(19) United States
(12) Patent Application Publication
(10) Pub. No.: US 2008/0231546 A1
(43) Pub. Date: Sep. 25, 2008

(54) Multi-Display System And Method Of Automatically Setting Display Mode

(75) Inventor: Zhongqing Li, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: Lenovo (Beijing) Limited, Beijing (CN)

(21) Appl. No.: 12/088,371

(22) PCT Filed: Mar. 22, 2006
(86) PCT No.: PCT/CN2006/000466

§ 371 Date: Mar. 27, 2008

(30) Foreign Application Priority Data
Sep. 28, 2005 (CN) 200510105615.1

(51) Int. Cl. G09G 5/12

(52) U.S. Cl. 345/3.4

(57) ABSTRACT

A multi-display system comprises a host, a main display, multiple second displays connectable to the host and multiple display detection units. The display detection units are adapted for detecting the statuses of the second displays and transferring detection signals to the host in real time. The host is adapted to record the display mode and display content of the currently connected second displays in real time, and conducts display control when receiving the detection signals from the display detection units. The host stops recording, saves the display content, modifies the display mode and transfers the content displayed by the second displays to the main display when the detection signals from the display detection units indicate the second displays have been disconnected from the host. Further, the host recovers the saved display mode and automatically sets the content displayed by the second displays based on the records of the second displays when the detection signal indicates that the second displays have been connected to the host. The present invention also discloses a method for automatically setting display mode in the multi-display system.

### BACKGROUND OF THE INVENTION

1. Field of Invention

The present invention relates to a display technique of a display system comprising multiple displays, and in particular to a multi-display system and a method of automatically setting display mode of such a system.

2. Description of Prior Art

Information display has gained a growing importance with the continuous development of computer and information technology. It can be seen from the history of computer development that, in the aspect of human-machine interface, the display size of a computer keeps growing bigger, starting from the original 14 inches to the current 17 inches, even up to 20 inches. The resolution also progresses from the initial CGA and EGA to the present high level of 1024*768 and even higher. The color is enriched from monochrome to 16 and 256 colors and now is commonly 24-bit representation. All of these changes indicate the display has been enabled to display more information than before.

On the other hand, it costs much to manufacture large-sized and high-resolution display devices (such as LCD and PDP, etc.) due to the limitation of display technology. Further, the viewing angle and position are limited for a single big-screen display. Therefore, it is generally a cost-saving and efficiency-improving method to utilize a number of screens to display more information content. In prior art, European Patent Publication No. EP 0827066 discloses an application of two displays on an ATM. UK Patent Publication No. GB 2333391 suggests a method for combining two smaller displays into a larger one.

Further, rapid progress has been made in display adapters which now have a strong capability of static and dynamic displaying. The display adapter currently used in a portable computer can generally support two displays to display different page content and behave well in display performance. Furthermore, in prior art, Japan Patent Publication No. JP2000-339130 discloses an application scenario of two displays. The method disclosed in JP2000-339130 first acquires content to be display in a large screen and then displays the content in the large screen. US Patent Publication No. US 2004263426 discloses a method of solving problem of switching display windows on two display devices in different display modes within one system.

FIG. 1 is a schematic diagram showing the operation when a portable computer is connected to a projector. As shown in FIG. 1, a host 1 is connected to a projector 3 via a cable 2. Then, a display mode is set on the host 1 as extended screen mode, and the screen (the second display) 5 for the projector 3 is set on the right side of the screen (the first display) 4 of the portable computer. After setting the display resolution and projection mode, the content of PPT file is projected on the screen 5 by the projector.

FIG. 2 is a schematic diagram showing another application mode of a multi-display system. As shown in FIG. 2, three files can be seen on three different displays 21, 22 and 23, respectively, by coupling two second displays 22 and 23 to a host 20, thereby improving work efficiency.

There are some setup methods for switching display mode of a second display as follows:
1. setting up through the keyboard of a notebook computer: after plugging in a second display, the display switching is defined via a screen switching key on the keyboard in the order of display of the notebook computer, the second display and the concurrent display on both of the displays;
2. selecting display mode via the control panel in operating system;
3. setting display mode in the control and driver application of a video card;
4. setting a shortcut key on the keyboard to select display mode conveniently, and recording all settings ever used so that, upon next power-on or recovery from hang-on, it is possible to automatically detect the presence of a display and restore the original settings (the method used in THINK PAD).

Unfortunately, the above four types of the existing technique cannot guarantee a real time and automatic setting of display mode every time the second display is plugged or unplugged. Consequently, the resetting operation is required after plugging or unplugging of the display, which leads to a troublesome operation and adverse effect on work efficiency and user experience. For example, if the display mode is set manually as extended display mode after a second display is plugged, there is no way to automatically return to the mode of a single display when the second display is disconnected. Thus, some content and windows displayed on the second display cannot be viewed after the disconnection of the second display, unless the display mode is set as the mode of a single display, or the system is reset or enters some sleeping shutdown status S3/S4/S5, from which status the system returns and enables an automatic setup of the display mode. In this way, however, it is by no means to display the content which is displayed on the second display after it is disconnected in a real time manner.

In prior art, US Patent Publication No. US 2002149541 discloses a method for connecting a PC to multiple displays, which can support digital and analog displays. In this method, a monitor for display cable connection is provided to set a dual-screen display based on the connection status of the display cable. This method, however, requires a detection circuit to be provided on the display adapter and cannot achieve a real time detection of connection to the display, since VGA BIOS works only upon the initialization of PC system.

U.S. Pat. No. 6,329,983 discloses another method which enables the system to learn the information of video signal being connected when S terminal or video signal is connected to a PC host. Such a method can solve only the problem with video signal and also requires a detection circuit to be provided at the signal output. Here, a micro-switch is adopted to act in response to the connection of a second video device, and thus the connection status is detected. This method can perform status setting during initialization since the connection status is under control of the video card.

The above two existing methods have a common feature of detecting the display output, such a feature requires cooperation from several aspects.

First, the display must comply with the standard of VESA (Video Electronics Standards Association).

As recommended in the standard of VESA, I²C and EDID (Extended Display Identification Data) are defined in DVI (Digital Visual Interface) interface and analog VGA (Video Graphics Array) interface to enable the function of PnP (Plug and Play) so that PC can know what type of display has been connected as soon as the display is connected to the PC. In this way, the PC system can set the parameters for the display automatically by reading the parameters on the display, including manufacture, product model, filter model, display timing sequence, display size, luminance, pixel array and the like. I²C and EDID are called DDC (Display Data Channel) as a whole. Due to a relatively high cost, most display manufactures omit this circuit portion to reduce the cost, and thus a large number of displays on commercial market do not fully comply with the standard of VESA, which makes a PC have difficulty in recognize the presence or absence of a display. Thus, the PC cannot determine whether the display has been connected since the PC can read no parameter from the display.

Next, the adapter must be modified accordingly.

In order to enable automatic reading of display parameters, the display adapter side is required to automatically identify the connection of a display. Thus, the display adapter needs to initiate a query task automatically and then give a notification to the PC system. For the same reason of reducing hardware cost, the circuit for I²C is usually omitted at the display adapter side, or even the corresponding pin is grounded directly. These measures lead to the impossibility of automatic detection and setup of second display.

In other words, the predominant problem with the prior art is that current display adapters cannot detect the connection status of a display in a real time manner.

FIG. 3 is a schematic diagram showing a computer architecture and display adapter in prior art.

This architecture comprises interfaces between various display devices and a PC. The internal AGP (Accelerated Graphics Post) interface can make use of inner memory of the system, and the display BIOS (Basic Input/Output System) is stored together with the system BIOS to reduce cost. The display adapter at the bus interface usually comprises display controller, display storage, display BIOS and all types of display transmitters for connecting different types of display devices.

The existing technology has a reservation for I²C bus in a display interface or detects data signals directly. The mechanism for detecting the connection status of a display is provided in the display adapter so that the task of status detection and notification to the system is fulfilled by the adapter and the driver application in the following manner. First, the display adapter performs detection on the status of the display in real time; then, the driver of the display adapter notifies the operating system of the status in time. On the other hand, the above method has the shortcomings as follows:
1. the method requires a high cost, since not only a storage needs to be provided on the display device for storing its own parameters, a circuit of reading the parameters and mechanism for notifying the system also need to be provided on the display adapter;
2. there are too much intermediate processes during system control, resulting in a reduced reliability of the system;
3. it is unlikely to compatible with all types of graphic output interfaces, such as non-VESA standard interfaces;
4. the method has difficulty in realizing an automatic and real time display switching;
5. the possibility of an automatic recovery to the original operating status is little.

In summary, for a multi-display system in the prior art, there exists several problems with the plugging, unplugging, switching and moving of the multiple displays, which bring much inconvenience to users as well as result in less efficiency and poor experiences of the users.

### SUMMARY OF THE INVENTION

In view of the defects of in prior art, the object of the present invention is to provide a multi-display system and a method for automatically setting display mode. With such a system and method, it is possible to automatically set a display mode upon a change in the status of a plurality of second display as well as to recover original display content.

According to an aspect of the present invention, there is provided a multi-display system comprising:

a main display;
at least one second display;
a host connected to the at least one second display for real-time controlling and recording the display mode and display content of the second display connected thereto currently;
a display detection unit for real-time detecting the connection status between the host and the at least one second display and transferring a detection signal to the host;
wherein the host stops recording the display mode and display content of the second display connected thereto currently, saves the currently recorded content, modifies the display mode and transfers the content displayed by the at least one second display to the main display when the detection signal from the display detection unit indicates the at least one second display has been disconnected from the host; and the host automatically sets the content displayed by the at least one second display based on the recorded display mode and display content of the second display when the detection signal indicates that the at least one second display has been connected to the host.

Preferably, the host comprises an second display content recorder for recording the display mode and display content of the second display connected to the host currently; a system window status recorder for recording window status corresponding to the display content of the second display that is recorded by the second display content recorder; and a system display mode controller started by the detection signal from the display detection unit for deciding the display mode and display content of the second display based on the content recorded by the second display content recorder as well as the window status recorded by the system window status recorder and transferring the decided display mode and the display content to a display memory of a corresponding display adapter.

Preferably, the number of the display detection unit corresponds to that of the at least one second display.

Preferably, the display detection unit detects the status of the second display by detecting EDID or by detecting the load of VGA signal.

Preferably, the display detection unit comprises a mechanical contact plug sensor, an infrared plug sensor and/or an optical plug sensor.

According to another aspect of the present invention, there is also provided a method for automatically setting display mode in a multi-display system comprising a main display and at least one second display. The method comprises the steps of:
1) recording a display mode and display content of the at least one second display in real time;
2) detecting the connection status between a host and the at least one second display and generating a detection signal indicating the connection status when a change occurs in the connection status between the host and the at least one second display;
3) stopping recording the display mode and display content of the second display connected thereto currently, saving the currently recorded content, modifying the display mode and transferring the content displayed by the at least one second display to the main display when the detection signal from the display detection unit indicates the at least one second display has been disconnected from the host;
4) automatically setting the display content of the at least one second display based on the recorded display mode and display content of the second display when the detection signal indicates that the at least one second display has been connected to the host.

Preferably, the step 4) comprises a step of searching for the recorded display mode and display content of the second display and searching for the current window status of the display content based on the display content.

Preferably, the display content recorded at the step 1) is attributes of a window displayed by the second display. Setting the display content at the step 4) comprises a step of deciding whether it is necessary to extract display data based on the window status or, extracting the display data and sending them to a display adapter if it is necessary, and extracting no display data temporarily and saving the original records if it is not necessary.

Preferably, it is decided to extract no display data when the window status is closed or minimized, and to extract and send display data based on the saved records when the window status becomes opened or maximized.

Preferably, the status of the at least one second display is detected at the step 2) by detecting EDID or by detecting the load of VGA signal.

Compared with the prior art, the present invention has several benefits. First, by recording the display mode and display content of the at least one second display in real time, stopping recording the content or searching for the saved recorded content after acquisition of the detection signal indicating the change in the status of the second display so as to recover the original display mode and automatically set the display content of the second display, the present invention enables an automatic and real-time switching of display mode upon the plugging and unplugging of multiple second displays, with no need for manual setting upon every plugging or unplugging. Further, the original display content can be automatically memorized, and corresponding display data can be extracted on the basis of records when a second display is connected. Therefore, the present invention provides an improved efficiency at the time of display plugging and unplugging in the multi-display system.

In preferred embodiments of the present invention, the recorded display content is the attributes of a window displayed by the second display other than the actually displayed data, which is resource efficient and allows real-time adjustment upon the change in the window status.

### BRIEF DESCRIPTION OF THE DRAWINGS

FIG. 1 is a schematic diagram showing the operation when a portable computer is connected to a projector;

FIG. 2 is a schematic diagram showing another application mode of a multi-display system;

FIG. 3 is a schematic diagram showing a computer architecture and display adapter in prior art;

FIG. 4 is a block diagram showing a multi-display system according to an embodiment of the present invention;

FIG. 5 is a block diagram showing the structure inside a host in the multi-display system of the present invention;

FIG. 6 is a schematic diagram showing the system architecture of the multi-display system according to the embodiment of the present invention; and

FIG. 7 is a flowchart showing a method for automatically setting display mode according to an embodiment of the present invention.

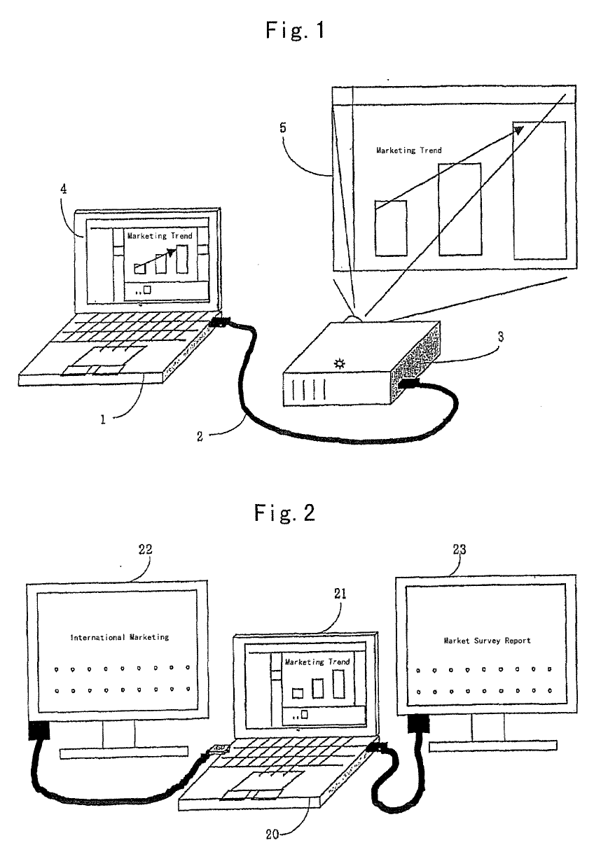

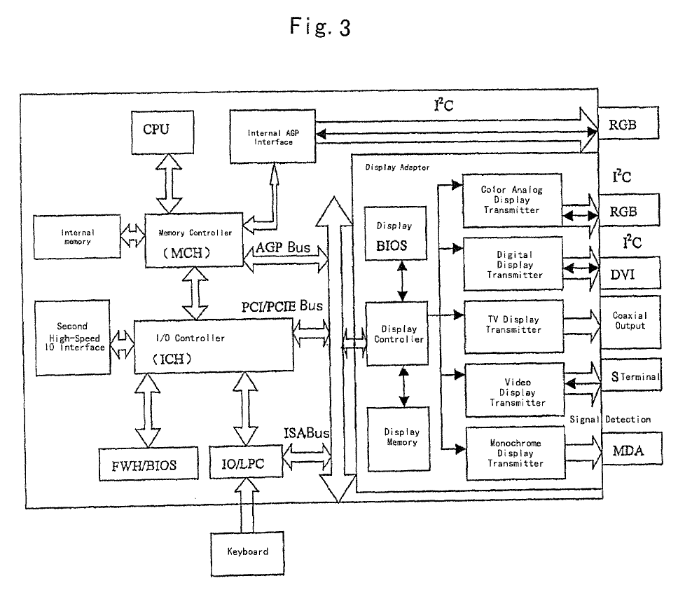

### DETAILED DESCRIPTION OF PREFERRED EMBODIMENTS

A multi-display system according to an embodiment of the present invention automatically records the connection status of the displays and the content displayed on the second displays in this status. When detecting the plugging or unplugging of any second display, the system automatically recovers the original display mode according to the recorded connection status of the display, determines and finds the content being currently displayed by the second display based on the records, or transfers the content displayed on the second display to a main display.

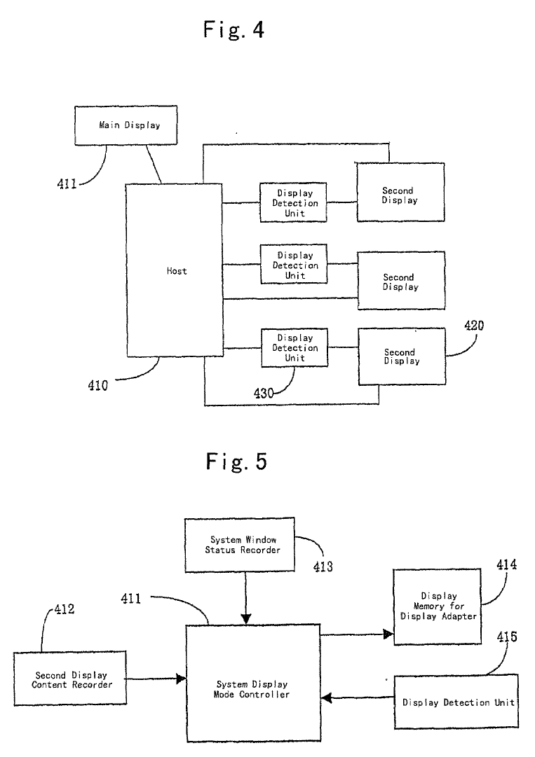

FIG. 4 is a block diagram showing a multi-display system according to an embodiment of the present invention.

Referring to FIG. 4, the multi-display system comprises a host 410, a main display 411 and multiple second displays 420 connected to the host 410 as well as display detection units 430 provided between the host 410 and these second displays 420.

The display detection units 430 are each configured to detect the plugging and unplugging of respective second displays 420 and to transfer their detection signals to the host 410.

The host 410 records the display mode and display content of any second displays 420 connected to the host currently in real time, and performs proper display control upon the reception of a detection signal from any display detection unit 430. More specifically, if the connection to at least one second display 420 is removed, the host 410 stops the recording, saves currently recorded content, modifies the display mode and transfers the content displayed on the second display 420 to the main display 411; if any of the second displays 420 is connected, the host 410 modifies the display mode based on its records and automatically sets the display content of the second displays 420 based on the recorded content corresponding to this newly connected second display 420.

Those skilled in the art will understand that these display detection units 430 can detect the second displays in various manners, such as by detecting EDID or detecting the load of VGA signal as known in the prior art, and the detailed description of these manners is omitted here.

FIG. 5 is a block diagram showing the structure inside a host in the multi-display system of the present invention.

As shown in FIG. 5, the host 410 comprises a system display mode controller 411, an second display content recorder 412, a system window status recorder 413, and a display memory for display adapter 414.

The second display content recorder 412 is configured to record the current display mode and display content of each second display.

The system window status recorder 413 is configured to record the window status of the display content recorded by the second display content recorder 412.

The system display mode controller 411 is activated by a detection signal from any of the display detection units 430 and configured to decide the display mode and display content of each second display based on the content recorded by the second display content recorder 412 and the status recorded by the system window status recorder 413, and to transfer the decided mode and content to a corresponding display memory for display adapter 414.

The recorded display content can contain the data currently displayed by the second displays and the attributes of the displayed windows, including position information. To be resource-efficient, only the attributes, including position information, of the windows currently displayed by the second displays are preferably recorded, while the displayed data can be extracted directly through the operating system.

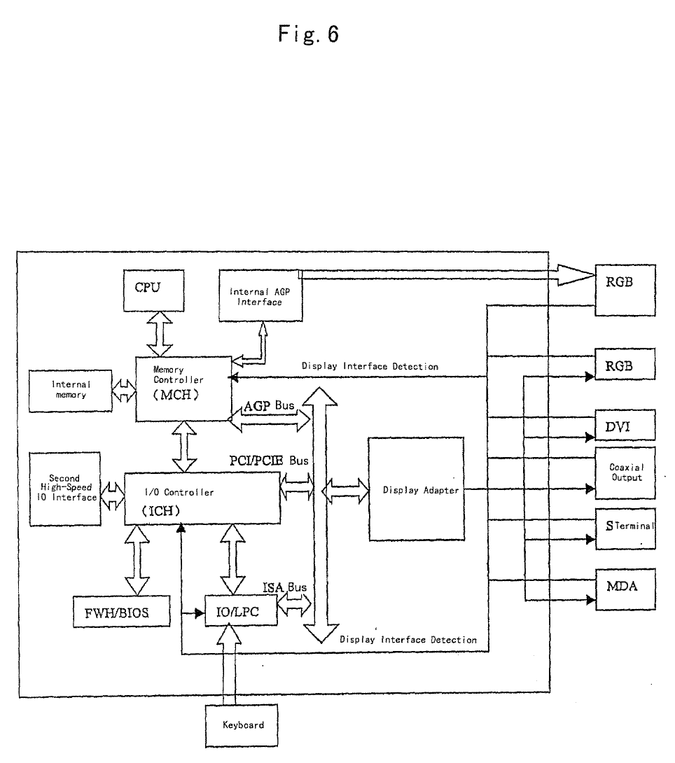

FIG. 6 is a schematic diagram showing the system architecture of the multi-display system according to one embodiment of the present invention.

Referring to FIG. 6, various connection cables and connection plugs are utilized to connect different types of displays and the PC system in the system architecture. The status of each second display is detected, and a detection signal is fed to an I/O controller of the system. By generating an interruption or query, the operating system and hardware of the system can be notified to send the desired display signals and display data to the second display. If the PC is of desktop computer, such a signal detection connection line will pass through the display adapter, which has no operation on the detection signal but sends it directly to the operating system.

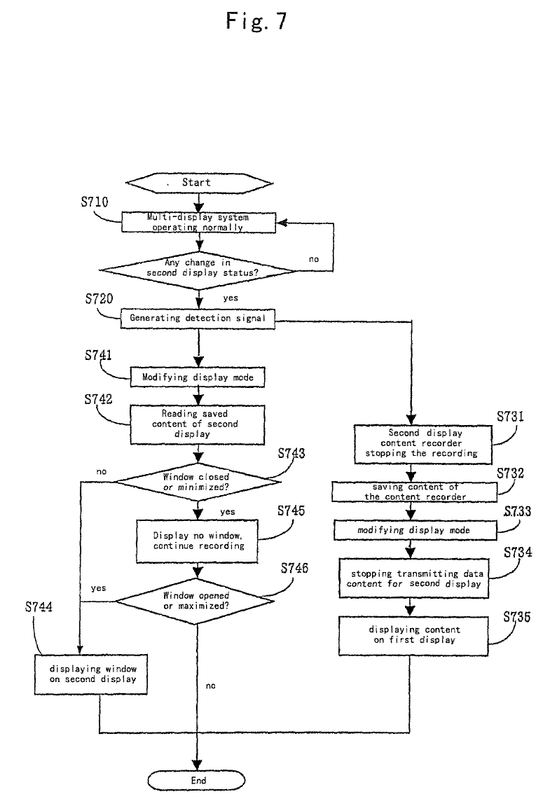

FIG. 7 is a flowchart showing a method for automatically setting display mode according to an embodiment of the present invention.

As shown in FIG. 7, this embodiment relates to a multi-display system including a host, a first display (a main display) and a second display (an external display). Here, for simplicity, the description is made only for one second display (one external display) by way of example. It should be noted that the host is not limited to connect only one second display, but may connect a plurality of second displays in the present invention.

The multi-display system operates normally at step S710.

At this period, if the second display secondly connected to the system is in a normal operation, the display manner is an extended screen display or a lengthened screen display. Further, the second display content recorder keeps working to record the display mode and display content of the current second display.

If the second display is not connected to the host, the display manner is a single-screen display, and the second display content recorder conducts no operation.

At step S720, it is detected whether the connection status of the second display has changed, and a detection signal indicating the connection status of the second display is generated if any change occurs.

At step S731, when the detection signal indicates the unplugging of the second display, i.e., when the I/O controller of the system receives a signal of unplugging, the second display content recorder is notified to stop its operation.

Records on the display mode and display content are saved at specific positions in the system memory at step S732.

Then, the display mode is modified at step S733.

The transmission of display data to the second display connected externally is stopped at step S734.

At the same time, the content displayed on the second display is sent to the first display at step S735. Here, if the display mode is in a lengthen screen, the screen will be shorten, which process is performed in real time.

At step S741, if the detection signal indicates that there exists a connection to the second display, i.e., the system detects the second display in real time, the display mode is first modified into extended or lengthen screen.

The saved display content of the second display is read at step S742.

At step S743, it is decided whether to send the display content to the second display based on the content saved by the second display content recorder and the recorded status of the system window, that is, whether the window is closed or minimized. If the answer is NO, the flow enters into step S744, otherwise the flow turns to step S745.

At step S744, the required display data is first sent to the display memory corresponding to the second display, and then the second display content recorder is activated.

No window is displayed while continuing to keep record at step S745.

At step S746, it is decided whether such operation is enabled as opening or maximizing a window, that is, whether there is change in the window status. The flow will come to the end if there is no change, otherwise the flow proceeds to step S744.

There are various methods to detect the second display, such as by detecting EDID or detecting the load of VGA signal as well-known in the prior art. The detailed description of these manners is omitted since they do not belong to the scope of the present invention.

Now, the present invention will be explained in connection to an example so that a deeper understanding can be gained.

This example relates to a portable computer which itself is connected to a LCD as the default display screen of the portable computer. A second display or projector (the second or external display) can be connected to the portable computer via its second VGA interface. The plugging and unplugging of the second display can be detected through any of techniques in the prior art or by providing, for example, a mechanical contact plug sensor, an infrared plug sensor and/or an optical plug sensor on the second display socket. The detailed description of these manners is omitted since they do not belong to the scope of the present invention.

When the user selects to use the extended dual-screen mode, different window content can be displayed on the display screen of the portable computer and the second display or projector, respectively. The second display has to be unplugged when the user wants to carry the portable computer away. Upon the unplugging, the detection unit for the second display detects immediately the signal indicating the unplugging and notifies the operating system, which becomes an interruption event for the operating system. After determining the source of the interruption event, the operating system modifies the display mode of the system into a single-screen display mode, and the display content on the second display is completely transferred to the display screen, which remains connected. On the other hand, when the user gets back to his office desk after his working out of office and connects the second display to the portable computer, the detection means delivers immediately the signal indicating the plugging of the second display and notifies the operating system through an interruption. Having determined and confirmed the interruption is associated with the plugging of the second display, the operating system first triggers the display setting system to set the same display mode as that before the unplugging of the second display, such as the extended dual-screen mode. Unless the window has been closed or minimized during the unplugging, the content in the saved record is all displayed on the second display according to the window content saved in the last record. Even if the file window has been closed or minimized during the unplugging, the recorder still saves the information before the unplugging of the second display. Therefore, if the window is maximized or opened after the second display is plugged again, the operating system also display the file or window on the second display based on the recorded information. Such an operation will not conduct for any deleted file or window, since the system saves no position information of the deleted file.

Only content related to the attributes of a window, such as the current position, size and the like, is saved in the second display content recorder, instead of recording the actual specific display data, and the specific content is read by the operating system from the system memory. In this way, the system resource can be conserved to the highest extent. Alternatively, all information can be saved directly.

In summary, the present invention relates to a system comprising a host and multiple display screens for information display and a method for automatically setting display mode, which can automatically detect the connection statuses of the multiple displays at any time and set the corresponding display mode.

The present invention is particularly applicable to a portable computer and enables the automatic setting of display mode when a second large display or projector needs to be frequently connected or removed.

The foregoing description gives only the preferred embodiments of the present invention. It should be understood that, to those ordinarily skilled in the art, various improvements and modifications can be made within the principle of the present invention and should be encompassed by the scope of the present invention.

1. A multi-display system comprising:
one main display;
at least one second display;
a host connected to said at least one second display for controlling and recording the display mode and display content of at least one second display connected thereto currently in real time; and
at last one display detection unit for detecting the connection status between the host and said at least one second display and transferring a detection signal to said host in real time;
wherein said host stops recording the display mode and display content of at least one second display connected thereto currently, saves the currently recorded content, modifies the display mode and transfers the content displayed by said at least one second display to said main display when the detection signal from said at least one display detection unit indicates said at least one second display has been disconnected from said host; and said host automatically sets the content displayed by said at least one second display based on the recorded display mode and display content of at least one second display when the detection signal indicates that said at least one second display has been connected to said host.

2. The multi-display system of claim 1, wherein said host comprises:
a second display content recorder for recording the display mode and display content of said at least one second display connected to said host currently,
a system window status recorder for recording window status corresponding to the display content of said at least one second display that is recorded by said second display content recorder, and
a system display mode controller started by the detection signal from said at least one display detection unit for deciding the display mode and display content of said at least one second display based on the content recorded by the second display content recorder as well as the window status recorded by the system window status recorder and transferring decided mode and content to a display memory for display adapter.

3. The multi-display system of claim 1, wherein the number of said at least one display detection unit corresponds to that of said at least one second display.

4. The multi-display system of claim 1, wherein said at least one display detection unit detects the status of said at least one second display by detecting Extended Display Identification Data (EDID) or by detecting the load of Video Graphics Array (VGA) signal.

5. The multi-display system of claim 1, wherein said at least one display detection unit comprises a mechanical contact plug sensor, an infrared plug sensor and/or an optical plug sensor.

6. A method for automatically setting display mode in a multi-display system comprising one main display and at least one second display, said method comprising the steps of:
1) recording the display mode and display content of said at least one second display in real time;
2) detecting the connection status between said host and said at least one second display and generating a detection signal indicating the connection status when a change occurs in the connection status between said host and said at least one second display;
3) stopping recording the display mode and display content of said at least one second display connected thereto currently, saving the currently recorded content, modifying the display mode and transferring the content displayed by said at least one second display to the main display when the detection signal indicates said at least one second display has been disconnected from said host;
4) automatically setting the display content of said at least one second display based on the recorded display mode and display content of said at least one second display when the detection signal indicates that said at least one second display has been connected to said host.

7. The method for automatically setting display mode of claim 6, wherein said step 4) comprises a step of searching for the recorded display mode and display content of said at least one second display and searching for the current window status of the display content based on the display content.

8. The method for automatically setting display mode of claim 7, wherein the display content recorded at said step 1) is the attributes of a window displayed by said at least one second display; setting the display content at said step 4) comprises a step of deciding whether it is necessary to extract display data based on the window status or, extracting the display data and sending them to a display adapter if it is necessary, and extracting no display data temporarily and saving the original records if it is not necessary.

9. The method for automatically setting display mode of claim 8, further comprising a step of deciding to extract no display data when the window status is closed or minimized, and to extract and send display data based on the saved records when the window status becomes opened or maximized.

10. The method for automatically setting display mode of claim 6, wherein the status of said at least one second display is detected at said step 2) by detecting Extended Display Identification Data (EDID) or by detecting the load of Video Graphics Array (VGA) signal.

11. The multi-display system of claim 2, wherein the number of said at least one display detection unit corresponds to that of said at least one second display.

12. The multi-display system of claim 2, wherein said at least one display detection unit detects the status of said at least one second display by detecting Extended Display Identification Data (EDID) or by detecting the load of Video Graphics Array (VGA) signal.

13. The multi-display system of claim 2, wherein said at least one display detection unit comprises a mechanical contact plug sensor, an infrared plug sensor and/or an optical plug sensor.

14. The method for automatically setting display mode of claim 7, wherein the status of said at least one second display is detected at said step 2) by detecting Extended Display Identification Data (EDID) or by detecting the load of Video Graphics Array (VGA) signal.

15. The method for automatically setting display mode of claim 8, wherein the status of said at least one second display is detected at said step 2) by detecting Extended Display Identification Data (EDID) or by detecting the load of Video Graphics Array (VGA) signal.

16. The method for automatically setting display mode of claim 9, wherein the status of said at least one second display is detected at said step 2) by detecting Extended Display Identification Data (EDID) or by detecting the load of Video Graphics Array (VGA) signal.
